(19) United States
(12) Patent Application Publication
(10) Pub. No.: US 2011/0153390 A1
(43) Pub. Date: Jun. 23, 2011

(54) METHOD FOR UNDERTAKING MARKET RESEARCH OF A TARGET POPULATION

(76) Inventor: Katie Harris, Frenchs Forest (AU)

(21) Appl. No.: 13/061,046

(22) PCT Filed: Jul. 30, 2010
(86) PCT No.: PCT/AU2010/000964

§ 371 Date: Feb. 25, 2011

(30) Foreign Application Priority Data
Aug. 4, 2009 (AU) 2009903646

(51) Int. Cl. G06Q 10/00

(52) U.S. Cl. 705/7.32; 705/7.33

(57) ABSTRACT

One embodiment provides a system 1 for undertaking market research of a target population 2. System 1 includes memory in the form of a database 3 for storing a first dataset 4 relating to a community 5 having a plurality of members 6. The first dataset 4 collectively includes first demographic data 7 for each member of community 5. A processor 8, included within a computer network 9, is responsive to dataset 4 and a demographic dataset 10 for creating a demographic profile 11 for community 5. The processor is also responsive to profile 11 and a demographic profile 12 for the target population for generating an indication of the representativeness 15 of community 5 relative to population 2.

### CROSS REFERENCE TO RELATED APPLICATIONS

This application is a U.S. national stage application filed under 35 U.S.C. §371 of International Patent Application PCT/AU2010/000964, accorded an international filing date of Jul. 30, 2010, which is incorporated herein by reference in its entirety.

### FIELD OF THE INVENTION

The present invention relates to systems and methods for undertaking market research, including systems and methods for the management and/or analysis of online communities from which market research data is collected.

Embodiments of the invention have been particularly developed for application in the context of gathering market research from online communities or online panels. This is done, for example, to obtain customer feedback on general service levels or product issues, and/or to evaluate new product or service ideas. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

It is known to undertake market research in an attempt to gain insights into the likely demand for specific goods and/or services amongst a target population or the level of satisfaction of existing goods and/or services that have previously been purchased by that population. Due to the expense and logistics involved in obtainingresearch from the entirety of the target population it is more usual to research only a sample of that population, which is either a subset of or at least much smaller than the total population. In this specification, the sample population is referred to as a “community” or “online community” or “panel” or “online panel”, and these terms are used interchangeably.

More recently, use has been made of online methods for collecting market research data from communities. While this medium offers some advantages, it has also been found to pose additional complexities in controlling the quality of sample and, therefore, the input provided by the community. More particularly, the individuals that actually participate in the market research—that is, those individuals who collectively form the community—are not necessarily representative of the target population for the goods and/or services. This is often a result of the input to the market research being obtained primarily on a volunteer basis. A conventional approach to reducing skews is to make use of financial or other inducements to specific individuals or types of individuals to join the community and provide feedback. This occurs in an attempt to provide a greater degree of confidence that the sample composition will reflect the characteristics of the population of interest and therefore, that the input provided by the community will be representative of the population that is being targeted by the research being undertaken. However, this in itself may simply skew the community to those open to financial or other inducements. Other techniques employed to gain confidence of representation include fulfilling recruitment quotas to the community based upon a general population distribution, or adopting specific segmentation criteria specified by the manufacturer or supplier of the goods and/or services.

When the online population is active, further methods are sometimes used to attempt to achieve ‘representative’ output, such as recruiting selectively into the community, such as by filtering, targeting question deployment, and/or weighting the answers provided by individuals.

While all the above techniques are widely believed to have some validity in improving the output quality of the market research undertaken, it is not clear what improvement, if any, each offers either individually or in combination, particularly in an online environment. This, in turn, considerably limits the manufacturer's or supplier's ability to draw strong conclusions from the output of online market research. It also has the side-effect of encouraging the use of larger sample populations or longer sample periods, which makes the research more expensive and increasingly likely to alienate potential or actual research participants.

### SUMMARY OF THE INVENTION

It is an object of the present invention to overcome or ameliorate at least one of the disadvantages of the prior art, or to provide a useful alternative.

One embodiment provides a computer-implemented method for undertaking market research of a target population, the method including the steps of: providing an online facility for cultivating an online community and obtaining market research response data from that online community, the community having a plurality of members, the community being a subset of the target population;

identifying data indicative of a first dataset relating to the community, wherein the first dataset collectively includes first demographic data for each member of the community;

using a microprocessor, comparing the first dataset with a demographic dataset, thereby to create a demographic profile for the community; and

using a microprocessor, comparing the demographic profile for the community with a demographic profile for the target population, thereby to generate data indicative of the representativeness of the community relative to the target population.

One embodiment provides a machine for undertaking market research of a target population, the machine comprising:

a microprocessor coupled to a memory, wherein the microprocessor is programmed to:

provide an online facility for cultivating an online community and obtaining market research response data from that online community, the panel being a community having a plurality of members, the community being a subset of the target population;

access a first dataset relating to a community, wherein the first dataset collectively includes first demographic data for each member of the community;

compare the first dataset with a demographic dataset, thereby to create a demographic profile for the community; and

comparing the demographic profile for the community with a demographic profile for the target population, thereby to generate data indicative of the representativeness of the community relative to the target population

One embodiment provides a computer-implemented method for undertaking market research of a target population, the method including the steps of:

obtaining a first dataset relating to a community, the community having a plurality of members and being a subset of the target population, wherein the first dataset collectively includes first demographic data for each member of the community;

using a microprocessor, comparing the first dataset with a demographic dataset, thereby to create a demographic profile for the community; and

using a microprocessor, comparing the demographic profile for the community with a demographic profile for the target population, thereby to generate data indicative of the representativeness of the community relative to the target population.

One embodiment provides a non-transitory computer-readable storage medium with an executable program stored thereon, wherein the program instructs a microprocessor to perform a method described herein

One embodiment provides a machine for undertaking market research of a target population, the machine comprising:

a microprocessor coupled to a memory, wherein the microprocessor is programmed to:

access a first dataset relating to a community, the community having a plurality of members and being a subset of the target population, wherein the first dataset collectively includes first demographic data for each member of the community;

the first dataset with a demographic dataset, thereby to create a demographic profile for the community; and

comparing the demographic profile for the community with a demographic profile for the target population, thereby to generate data indicative of the representativeness of the community relative to the target population.

According to a first aspect of the invention there is provided a method for providing an indication of representativeness of a community relative to a target population, the method including the steps of:

a) obtaining a first dataset relating to the community having a plurality of members, where the first dataset collectively includes first demographic data for each member of the community;

b) being responsive to the first dataset and a demographic dataset for creating a demographic profile for the community; and

c) being responsive to the demographic profile for the community and a demographic profile for the target population for generating an indication of the representativeness of the community relative to the target population.

In an embodiment, the method includes the step of obtaining a second dataset relating to the target population, where the second dataset collectively includes second demographic data for each member of the target population.

In an embodiment, the demographic profile for the target population is derived from one or both of: the second dataset; and the demographic dataset.

In an embodiment, the first demographic data and the second demographic data are for corresponding demographic characteristics of the respective populations.

In an embodiment, the demographic characteristics include one or both of: age characteristics for each member of the relevant population; and location characteristics for each member of the population. When a demographic characteristics includes a location characteristic it defines a geo-demographic characteristic.

In an embodiment, the demographic characteristics include one or more of: age;

socioeconomic status indicators such as at least one of income, education, and occupational status; household and family composition; cultural factors such as one or more of ethnicity, language spoken, country of birth, and religion; employment factors such as type of job, type of industry, and hours of work; and household economic factors, like indebtedness, investments, and poverty.

In an embodiment, the demographic dataset is for a large population.

In an embodiment, the demographic dataset is derived from population information for a given region.

In an embodiment, the given region is selected from: a county or municipality; a state; a country; or a combination of two or more regions of the preceding types of regions.

In an embodiment, the region is a country and the population information is census data for the population of that country.

According to a second aspect of the invention there is provided a computer system including a processor configured to perform a method according to the first aspect.

According to a third aspect of the invention there is provided a computer program product configured to perform a method according to the first aspect.

According to a fourth aspect of the invention there is provided a computer readable medium carrying out a set of instructions that when executed by one or more processors cause the one or more processors to perform a method according to the first aspect.

According to a fifth aspect of the invention there is provided a system for providing an indication of representativeness of a community relative to a target population, the system including:

memory for storing a first dataset relating to the community, where the community has a plurality of members and the first dataset collectively includes first demographic data for each member of the community; and a processor that is:
a) responsive to the first dataset and a demographic dataset for creating a demographic profile for the community; and
b) responsive to the demographic profile for the community and a demographic profile for the target population for generating an indication of the representativeness of the community relative to the target population.

According to a sixth aspect of the invention there is provided a method for undertaking market research of a target population, the method including the steps of:

a) obtaining a first dataset relating to a community having a plurality of members, where the first dataset collectively includes first demographic data for each member of the community;

b) being responsive to the first dataset and a demographic dataset for creating a demographic profile for the community; and

c) being responsive to the demographic profile for the community and a demographic profile for the target population for generating an indication of the representativeness of the community relative to the target population.

According to a seventh aspect of the invention there is provided a computer system including a processor configured to perform a method according to the sixth aspect.

According to an eighth aspect of the invention there is provided a computer program product configured to perform a method according to the sixth aspect.

According to a ninth aspect of the invention there is provided a computer readable medium carrying out a set of instructions that when executed by one or more processors cause the one or more processors to perform a method according to the sixth aspect.

According to a tenth aspect of the invention there is provided a system for undertaking market research of a target population, the system including:

memory for storing a first dataset relating to a community having a plurality of members, where the first dataset collectively includes first demographic data for each member of the community; and

a processor that is:
a) responsive to the first dataset and a demographic dataset for creating a demographic profile for the community; and
b) responsive to the demographic profile for the community and a demographic profile for the target population for generating an indication of the representativeness of the community relative to the target population.

According to an eleventh aspect of the invention there is provided a method of populating a community from an available population having a plurality of members, the method including the steps of:

a) defining a demographic profile for a target population;

b) obtaining a first dataset relating to the available population, where the first dataset collectively includes first demographic data for each member of the community; and

c) being responsive to the first dataset and a demographic profile for selecting members to populate the community.

In an embodiment, step (c) includes: being responsive to the first dataset for generating a demographic profile for the community; and then being responsive to the demographic profile for community and the demographic profile for the target population for generating an indication of the representativeness of the community relative to the target population.

In an embodiment, the members are selected to provide a predetermined representativeness for the community. In an embodiment, the members are selected to increase the representativeness of the community.

In an embodiment, the members are selected so as not to decrease the representativeness of the community.

According to a twelfth aspect of the invention there is provided a computer system including a processor configured to perform a method according to the eleventh aspect.

According to a thirteenth aspect of the invention there is provided a computer program product configured to perform a method according to the eleventh aspect.

According to a fourteenth aspect of the invention there is provided a computer readable medium carrying out a set of instructions that when executed by one or more processors cause the one or more processors to perform a method according to the eleventh aspect.

According to a fifteenth aspect of the invention there is provided a system of populating a community from an available population having a plurality of members, the system including:

a) memory for storing: data indicative of a demographic profile for a target population; and a first dataset relating to the available population, where the first dataset collectively includes first demographic data for each member of the community; and

b) a processor that is responsive to the first dataset and a demographic profile for selecting members to populate the community.

In some embodiments the community includes a hybrid community created by combining an online community and offline community.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

Preferred embodiments of the invention will now be described, by way of example only, with reference to the accompanying drawings in which:

FIG. 1 is a schematic representation of a system according to an embodiment of the invention;

FIG. 2 is a schematic representation of a database used in the embodiment of FIG. 1;

FIG. 3 is a schematic representation of the parties interacting with the system of FIG. 1;

FIG. 4 is a flowchart illustrating the steps of acquiring market research data;

FIG. 5 is a flowchart illustrating the steps of obtaining an indication of representativeness for the online community relative to the target population;

FIG. 6 is a pictorial representation of the profiles of the online community and the target population respectively, assessed against like segments;

FIG. 7 is a pictorial representation of the segments for the respective profiles shown in side-by-side relationship together with an indication of representativeness; and

FIG. 8 is a flowchart illustrating the steps of obtaining an indication of representativeness for the online community relative to a target population which is the total population of a country or region.

### DETAILED DESCRIPTION

Described herein are systems and methods for undertaking market research and systems and method for providing an indication of representativeness of a community relative to a target population.

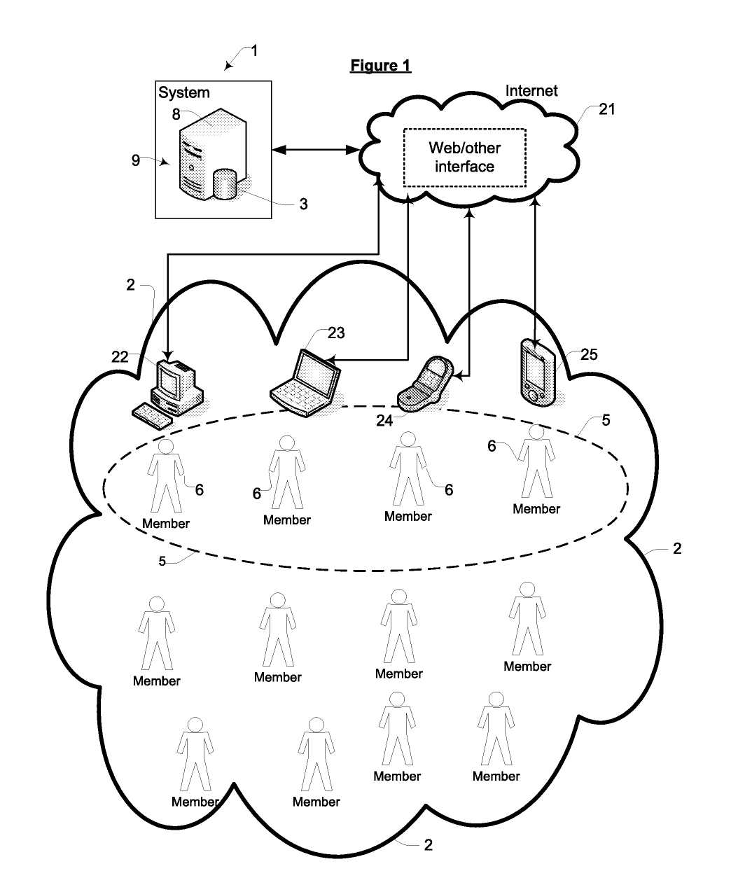

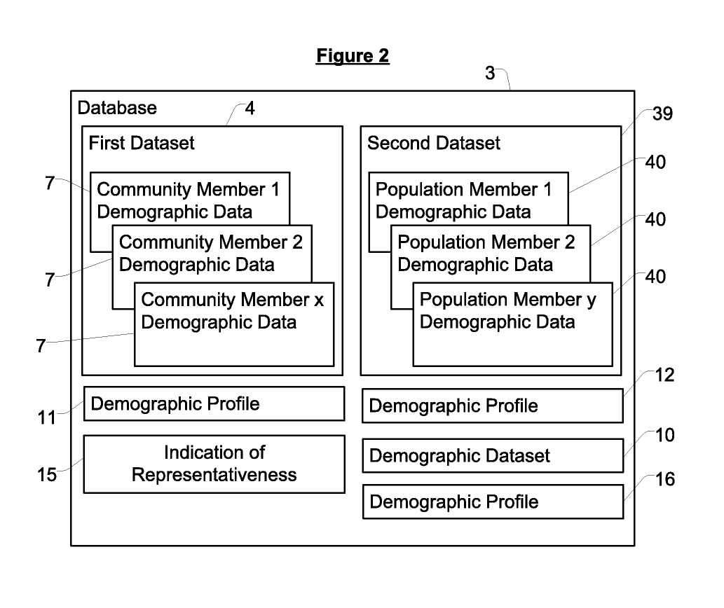

Referring to FIG. 1 and FIG. 2 there is illustrated a system 1 for undertaking market research of a target population 2. System 1 includes memory in the form of a database 3 for storing a first dataset 4 relating to a community 5 having a plurality of members 6. As best shown in FIG. 2, the first dataset 4 collectively includes first demographic data 7 for each member of community 5. Referring again to FIG. 1, a processor 8, included within a computer network 9, is responsive to dataset 4 and a demographic dataset 10 for creating a demographic profile 11 for community 5. The processor is also responsive to profile 11 and a demographic profile 12 for the target population for generating an indication of the representativeness 15 of community 5 relative to population 2.

Although it is possible to conduct representativeness-type analysis manually on a case-by-case basis (for example to better understand the results of a particular market research exercise), a key aspect of system 1 in some embodiments is the ability to expand the availability of such analysis for wider-scale commercial application. This includes the ability to cultivate an online community, and conduct analysis of that community thereby to understand the representativeness of the community in the context of a target population for various purposes. For instance, those purposes may be either retrospective (e.g. understanding particular responses) or proactive (developing an appropriate community with desired representativeness characteristics).

As shown, all the data input and outputs (intermediate or final) are stored in database 3. In other embodiments, different data inputs and outputs are stored in other databases or carrier media. Moreover, in some embodiments, database 3 is distributed across a number of carrier media. Additionally, it will be appreciated that in other embodiments the datasets include additional data about the members or other parties.

The first demographic data 7 includes for each member an age characteristic and a location characteristic. More specifically, the age characteristic is the age of the member in years, and the location characteristic is the residential address for that member. In other embodiments, different or additional age and location characteristics are used, for example: age characteristics such as the duration of the member's inclusion within the community; and the duration of the member's employment with a particular corporation or other organization. Examples of other location characteristics include the location of the member's employer. Other characteristics of members that are also selectively captured and used in some embodiments include: socioeconomic status indicators such as at least one of income, education, and occupational status; household and family composition; cultural factors such as one or more of ethnicity, language spoken, country of birth, and religion; employment factors such as type of job, type of industry, and hours of work; and household economic factors, like indebtedness, investments, and poverty. This data is collected, stored and controlled in accordance with the relevant laws and regulations for each jurisdiction in which system 1 operates. It will be appreciated that additional or alternative age and location characteristics are used in other embodiments.

Demographic dataset 10 is census data obtained from one or more government agencies or similar bodies. That is, dataset 10 is demographic data for the total population as a whole of a given state, country or other region. Preferentially, dataset 10 is for as large a population as possible, which makes national census data preferred over state census data, for example. In some embodiments, use is made of census data from more than one jurisdiction or region that are combined together.

Dataset 10 is able to be processed by processor 8 to provide the demographic profile 16 for the total population represented in the census data contained within dataset 10. This profile 16 is based upon segments that are earlier identified to be of interest. For example, the segments include those with annual incomes greater than a threshold, those who are a single parent, those who have more than one child under 5 years old, and so on. These segments are able to be defined, as required, and often include multiple criteria. The segments are typically preselected and expressed as a percentage of the total population. In the embodiments described herein use is made of a plurality of segments in developing profile 16. However, in other embodiments, a single segment is used. In some embodiments, profile 16 is not developed.

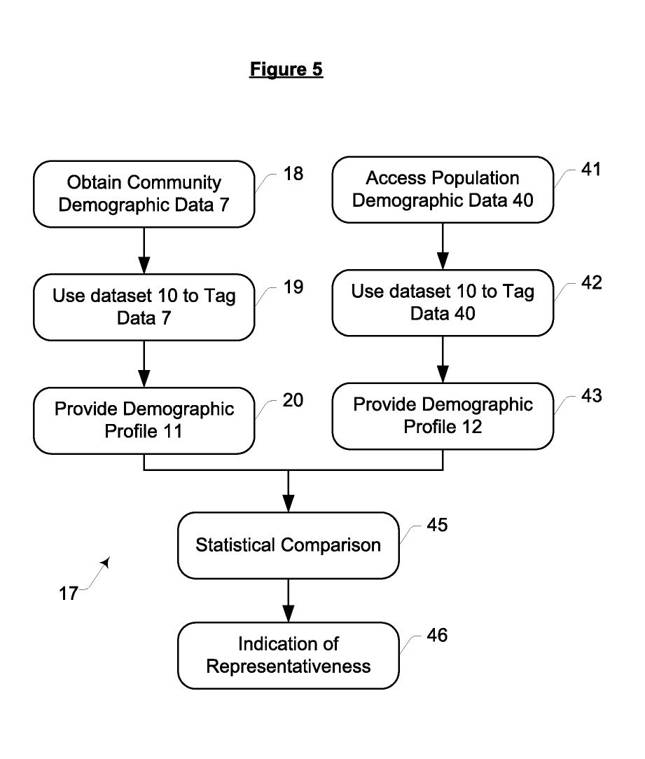

Processor 8 is also responsive to dataset 10 for tagging data 7 to develop profile 11 for community 5. This is represented in FIG. 5 as a process 17 and, in particular, steps 18, 19 and 20 of process 17. Profile 11 is based upon the same preselected segments discussed above and is able to be summarized or presented as percentages for each segment. That is, profile 11 provides an indication of the proportion of community 5 that falls within the preselected segments, based upon calculations that make use of the age and location characteristics included within demographic data 7 and the census data. The details of the underlying calculations used to tag data 7 and develop profile 11 will be known to those skilled in the art of demographic profiling.

Members 6 communicate online with system 1 via one or more selected media and devices. By way of example, FIG. 1 illustrates one member 6 who connects to system 1, via the internet 21, with a desktop PC 22. Other members 6 make respective use of a laptop computer 23, a web-enabled cellular telephone 24 and a web-enabled PDA 25. It will be appreciated that other devices (not shown) are available to allow connection of members 6 to system 1, and that individual members are able to use different devices at different times to connect.

Target population 2 is illustrated as including community 5. That is, each member of community 5 is also a member of population 2. However, in other embodiments community 5 overlaps with population 2 and, in further embodiments, falls entirely outside population 2.

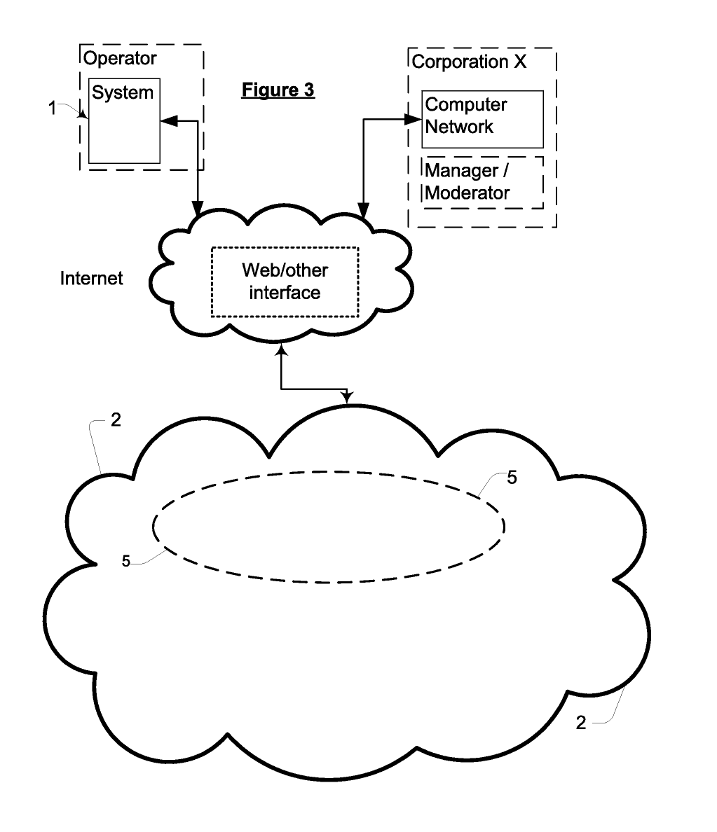

To illustrate the operation of system 1 an example is given in FIG. 3 of a commercial organization, corporation X, which makes use of community 5 and engages an operator of system 1 for generating an indication of the representativeness 15 of community 5 relative to population 2. More particularly, corporation X cultivates community 5 as an online community or an online panel for market research purposes. That is, the intention of supporting and sustaining the community is to obtain, over time, customer feedback. That feedback is, in some instances, about services and/or products supplied by corporation X and/or its competitors. In other instances, the feedback is sought to evaluate potential, intended or soon-to-be-released products and/or services.

The online activity and interactions between members of community 5 is monitored and typically moderated by community managers/moderators via a computer network 26. This network also hosts the web pages used by community 5, although in other embodiments external hosting is used.

The managers (or moderators) are often employees of corporation X, but in other embodiments are external parties such as consultants or other specialists in the field of online community management. The managers drive discussion within the community. This includes, for example, identifying and encouraging discussion on topics developed within corporation X or topics which arise as a matter of course during other discussions within community 5. For example, the managers are able to ask questions to individual members or to the community as a whole. Those questions are able to be about the individual members, the entity represented by the member (for example, a further corporation that is a customer of corporation X), branding of products and/or services, products offered by corporation X or corresponding products offered by competitors, services offered by corporation X or corresponding services offered by its competitors. These questions are typically in the form of one or more of: an online discussion or discussion thread; a poll that is set up in the community over a predetermined time; or a survey link. However, other community participation devices are available and suitable for use in conjunction with the embodiments of the invention.

Community 5 is a “sample” of the total population of a given state, country or region. However, to better determine what weight to place upon the input gained from this community the embodiments of the invention look to first gain an indication of how well that “sample” represents that wider population.

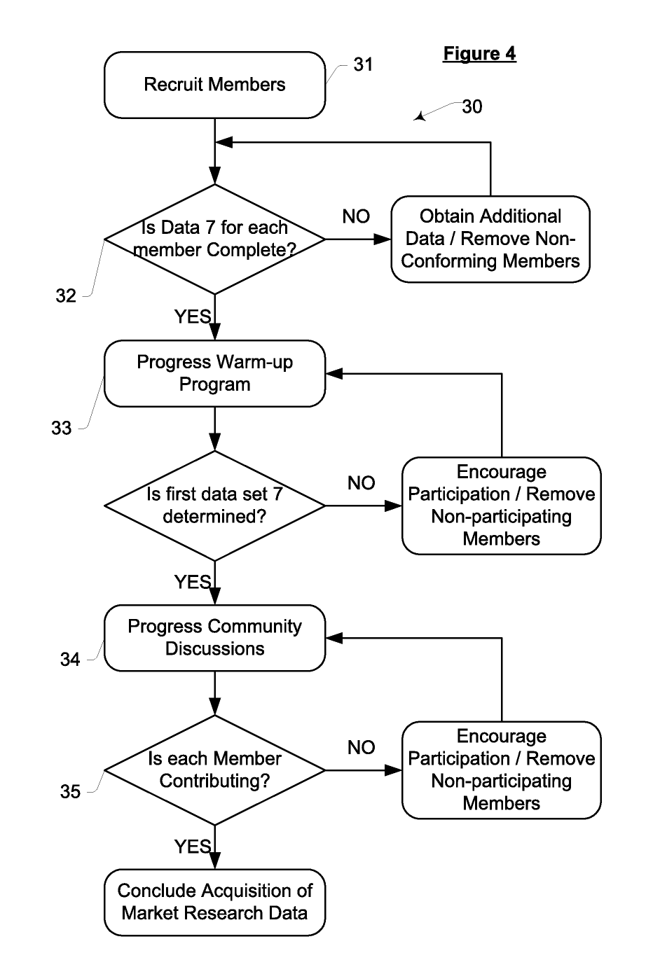

In the present embodiment, corporation X invites to community 5 all of its present customers for a given product. It will be appreciated that a similar approach is able to be taken for a given service, for multiple products or services, or for a combination of products and services. The recruitment step is represented in the process 30 of FIG. 4 at step 31. The invitation is dispatched, for example, by one or more of: email; regular post; and an in-store flyer. The dispatch method will be dependent upon the nature of the customers and the distribution network or networks. As will be appreciated, although the invitation is made to all customers of the give product, those that take up the invitation and join the community will usually be a lesser number. For it will be limited to those people who are: willing to join; have the time to join; and comfortable enough with online communication to feel confident to join. Accordingly, even at this early point the “sample” or community begins to be skewed. The skews within the sample further compounds as the members are signed up, for some will simply not participate in community discussions, while some others will only participate in those discussions for a short duration or only sporadically participate.

By way of example, corporation X wished to form an online community from all its customers on its customer database to gain feedback about a specific product. To automate the process, an invitation was issued to the customers via email. However, as the records held in the customer database only had email addresses for 90% of the customers, only those 90% of customer received the invitation. Once the invitations were issued, error messages—such as email bounce-backs—were received for a further 10% of the customers. Accordingly, only 80% of the total customers received their invitation. Of that 80%, 20% actually responded to the invitation, and agreed to sign-up to be a part of community 5. That is, the actual members represent only about 16% of the total number of customers. In agreeing to sign-up the individual members are required to consent to providing a minimum level of information about themselves, including age and location data. Process 30 includes the step 32 of seeking this data.

During the first week of the community's existence, the manager provides a variety of warm-up exercises to familiarize the members of the community with the interface. This is represented in FIG. 4 as step 33. During this period, about 25% of the initially signed-up members leave community 5. This reduces the number of members to be about 12% of all the known customers.

The community is then allowed to operate, as illustrated at step 34. During this time, and as illustrated at step 35, the contribution of each member is assessed to provide an indication of the level and usefulness of that contribution. In the present example, it is found that only 30% of the online members contribute usefully to the community discussions. This has the effect of skewing the effective feedback even further. That is, the useful contribution gained from the community, in this example, is being provided by about 4% of actual known customers.

To summarise, the ‘sample’ or community has been skewed towards those who:
Have an email address (90%).
Received the email invitation (80%).
Responded to the email invitation and agreed to sign-up for the community (16%).
Did not leave the community before contributing to the research process (12%).
Are active community members (4%).

The recruitment process has effectively reduced the sample composition from a representation of “all customers” or “the target population” for the given market research, to one that can only be said to represent those who fit the profile of “active community members within the customer data base”.

The percentages used in the above example are, while not being atypical, illustrative only.

In recognition of the above skews, the inventor has developed a method for providing an indication of representativeness of community 5 relative to population 2, which will be described in further detail below.

Continuing with the example provided above, it will be appreciated that the members of community 5 are a subset of population 2 which, in turn, are a subset of the overall population of the country in which population 2 is located. Demographic dataset 10 is, in this embodiment, census data for the overall population of that country.

Referring to FIG. 4, the process includes a final step 36 of concluding the acquisition of the market research data for that particular market research project. Once that occurs, database 3 includes, as shown in FIG. 2:
A completed dataset 4 for the active members—which, in the example, comprises about 4% of the target population.
A demographic dataset 10 in the form of census data.
A demographic profile 11 for community 5.

In some embodiments, dataset 10 is held by another party and the development of profile 11 is carried out by that party.

Also held in database 3 is a second dataset 39 that collectively includes second demographic data 40 for each member of population 2. This demographic data 40 is representative of one or more demographic characteristics of the members of population 2. Preferentially, the demographic characteristics represented in dataset 39 correspond with the demographic characteristics selected for dataset 4. In other embodiments, dataset 39 includes a greater number of demographic characteristics than included in dataset 4. In the present example, the demographic data 40 includes an age characteristic and a location characteristic for each member of population 2.

Processor 8 is also responsive to dataset 10 for tagging data 40 to develop profile 12 for population 2. This is represented in FIG. 5 as steps 41, 42 and 43 of process 16. Profile 12 is based upon the same preselected segments discussed above with reference to profile 11 and is able to be summarized or presented as percentages for each segment. That is, profile 12 provides an indication of the proportion of community 5 that falls within the preselected segments, based upon calculations that make use of the age and location characteristics included within demographic data 40 and the census data. The details of the underlying calculations used to tag data 40 and develop profile 12 will be known to those skilled in the art of demographic profiling.

At this stage of the process there are at least two profiles available, that being profile 11 for community 5 and profile 12 for population 2. In some embodiments there will also be a profile 16 for the general population.

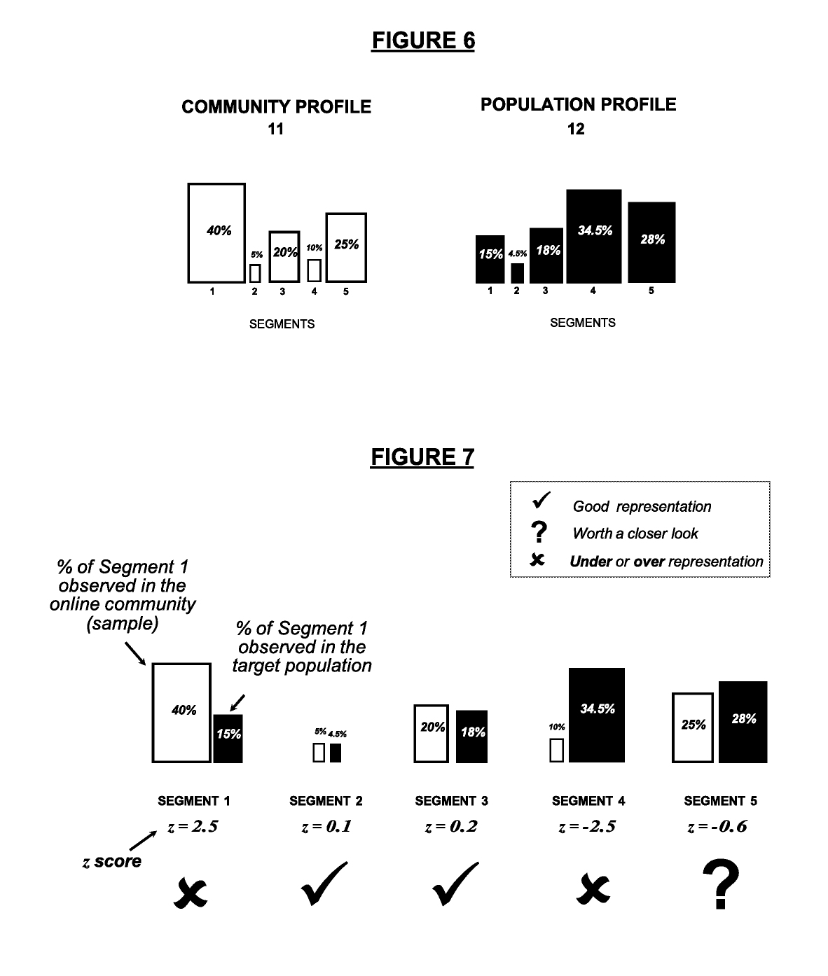

FIG. 6 provides a schematic illustration of example profiles 11 and 12. These profiles are built upon five distinct segments, sequentially numbered 1 to 5. It will be appreciated that correspondingly numbered segments are based upon the same criteria or criterion. Additionally, and due to the different membership of community 5 and population 2, profiles 11 and 12 differ. However, it is only feedback from community 5 that has been obtained. To gain an indication of the representativeness of this feedback relative to the entire customer base (that is, relative to population 2) additional steps are provided by process 17. Particularly, returning again to FIG. 5, step 45 provides a comparison of profiles 11 and 12 by way of a statistical analysis. This allows for a quantification of any differences and/or similarities between profiles 11 and 12 which, in turn, provides an indication of representativeness at step 46. This indication is able to be represented pictorially, such as shown in FIG. 7. It will be appreciated by those skilled in the art, with the benefit of the teaching herein, that the indication of representativeness is able to be represented in many other ways.

For the example given, the skews involved in using the smaller community 5 are highlighted in FIG. 7. In addition to the pictorial representation of the results, there is also provided for each segment the z-scores. This provides the addressee with a quantitative indication of the community's representativeness for that segment. That is, it indicates numerically the extent to which the online sample or community is representative (or not) of the target population of interest. More particularly, after applying the above methodology of comparing profile 11 and 12, it has been found that while 40% of community 5 has been identified as Segment 1, this segment is only 15% of corporation X's actual customer database. This represents a substantial skew and lack of representativeness for that segment.

To facilitate understanding and cognizance of the results provided by the above methodology, the results (as shown in FIG. 7) present side-by-side for each segment in the two profiles:
The percentage of members in the segment.
The z-score indicating the size of difference between the two like-segments in the community and the target population.
A visual symbol of a red cross, a green tick or a caution sign to indicate over-representativeness or under-representativeness, closely aligned representativeness and marginally aligned representativeness respectively.

One of the benefits of the above process is that it provides greater insight to the managers/operator when analyzing and weighting the data acquired during the market research project. This, in turn, will contribute to better informed decisions about the likely success of potential or soon to be released products and/or services.

The embodiments of the invention, in addition to providing benefits post the acquisition of the marketing data, also allows for pre-processing to occur to develop more representative communities, or to only use the feedback from members 2 who collectively define a more representative sample.

For example, in some embodiments, processor 8 develops a plurality of profiles 11 for community 5 based upon different combinations of members 2 and assesses which of those profiles have the best measure of representativeness relative to profile 12. In turn, the feedback provided by the members included within the ultimately selected profile 11 is provided greater weight.

In another embodiment, the recruitment of members 2 to community 5 is left open even once the community is operating. As a new member seeks to enroll (or after a number of new members seek to enroll) a new profile 11 is developed. If this profile is more closely representative of profile 12, then the input of the new members is more heavily weighted.

It will be appreciated that profile 12 is able to be for a target population that is not made of members who are existing customers of corporation X. For example, the target population is, in some embodiments, members who corporation X is desirous of having as customers. It is possible, in this embodiment, to make use of community 5 having members from the existing client base of corporation X, or otherwise.

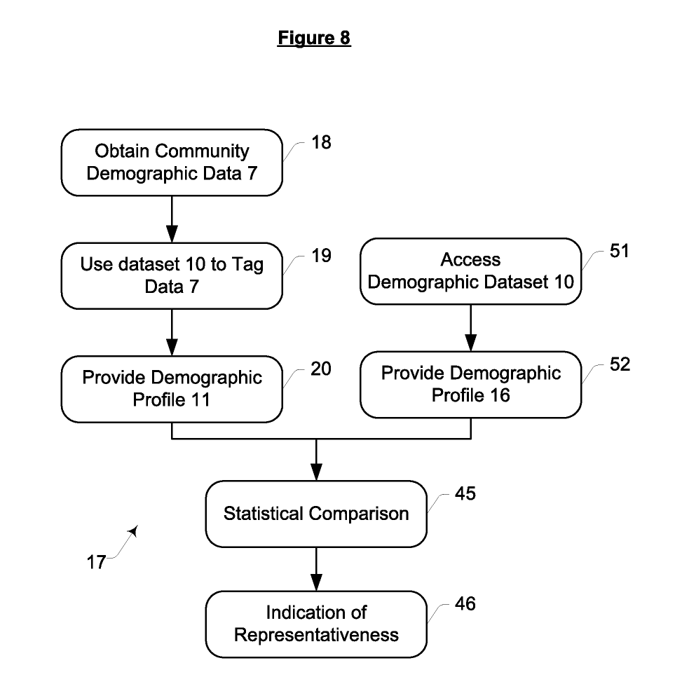

In a further embodiment, process 17 is as shown in FIG. 8, where corresponding features are denoted by corresponding reference numerals. In this embodiment, the target population is the total population of a country or region, and access is made at step 51 to dataset 10 to generate at step 52 a demographic profile 16 for the entire population of that country or region. It is profile 11 and profile 16 that are then compared at step 45 to then provide the indication of representativeness at step 46. It will be appreciated that in this embodiment, there is gained an indication of the representativeness of the community relative to the population of the country as a whole.

Comparison to the profile of the total population is done more typically to plan for large-scale state or national marketing campaigns such as that used by larger corporations or government bodies. It is also particularly useful for products and/or services that are widely purchased across a country or state , such as:
Financial products—for example, insurance, financial planning and banking products.
Commodity food products—for example, salt, sugar and the like.
Personal hygiene products—for example, dental care products (toothpaste, toothbrushes, mouthwash), sanitary wear, deodorants, and other toiletries.
Motor vehicles.
Petrol, electricity, gas and other residential or commercial energy forms.
Legal services, accounting services and other professional services.

The major benefits of the above embodiments of the invention include:
A gauge of whether certain segments are over or under represented. For example, to determine whether the feedback being obtained from an online community actually reflects the sentiment or attitudes held by more than just a small minority of community members.
A means for obtaining greater insight into the sentiment/attitudes in the wider population of interest, such as the whole customer base, or the target market.
Providing marketers with a greater indication of those issues that require a marketing as opposed to a customer-relations response. In other words, better understanding the overall sentiment about the issue before committing considerable marketing resources to address the issue.
Gaining a greater understanding of: which members populate the online community; and how the community's profile matches (or doesn't match) the broader customer/potential customer base.
How the online community is skewed/biased.
Allows the specific identification of the source of any insights from members, without necessarily having to identify the members by name. Should the insights arise from only a small number of the members in the community, this may suggest that a more cost-effective methodology should be used to address the relevant issues. For example, simply contacting those members individually or making use of a “bulletin board” style focus group.
A gauge of each member's contribution to the compiled marketing research data. That is, the embodiments allow the operator and/or manager to more accurately assess the return on invention (ROI) for each member of the community. This also provides an indication of the community's efficiency.

All the above advantages contribute to the relevant manager or marketing professional having additional and targeted information. This, in turn, contributes to more informed and efficient business and marketing decisions.

Having an indication of representativeness of a community relative to target population is of great assistance in analyzing and weighting input from the community. This is particularly so for market research that relies upon a community that is drawn from a wide cross-section of society and which is relatively untargeted. However, having an indication of representativeness also allows for further advantages. More particularly, in some embodiments, each member of an available population is tagged (with one or more characteristics) and individual profiles developed for each member. The individual profiles are then used to provide a profile of the community, which is assessed relative to the target population prior to the gathering of input from the members on the market research topic. This allows for an indication of representativeness to be generated before any substantive input is received. This, in turn, allows for one or more of: recruiting of additional members to increase the indication of representativeness by approaching members with suitable demographic profile; recruiting of additional members while not decreasing the indication of representativeness; and removing one or more existing members from the community. Accordingly, it is possible to use this embodiment to reduce the skews—or increase the representativeness—in the initial stages of the market research.

In some embodiments a hybrid online/offline approach is adopted whereby an online community is supplemented with an offline community. In this sense, “online” here refers to potential respondents listed on an online market research panel database (used to form a community as discussed above). On the other hand, offline refers to the likes of:
Potential research participants who may be contacted to take part in a telephone interview (e.g. potential telephone omnibus study respondents).
Potential respondents listed in the form of a customer data base.
Potential respondents who may be contacted to take part in a face to face interview.
Potential respondents who may be contacted to take part in mobile phone research etc).

Various other examples are present in further embodiments. In a general sense, “offline” refers to substantially any participant (or partial participant) that participates via a communication mechanism other than interaction with an online portal that engages an online community.

A hybrid online/offline is optionally used to provide a more robust sample to survey, and manage various skews that may arise due to the nature of participants in online facilities. In many cases, online market research panel samples (targeted groups of research participants) are found wanting in terms of their ability to provide robust, reliable output. A key factor here sample bias—certain market segments may be over or under represented in the online market research panel sample. This directly affects the ability to generalize research findings to a wider target population, as could be observed by an indication of representativeness defined in accordance with embodiments described above.

Hybrid online/offline embodiments make use of an online community (for example as described further above) and an offline community, which are collectively referred to as a hybrid community. Demographic datasets are maintained for the online community and offline community, and accordingly a hybrid dataset is available to describe the hybrid community. In some embodiments a hybrid approach is implemented thereby to
Provide an indication of the entire hybrid community's geodemographic composition.
Identify—and thus define—the extent to which the hybrid community's composition (be it an existing or theoretically ideal composition) is representative/fit for purpose in relation to any given target population.

More specifically, some embodiments profile:
Individuals within the hybrid community.
Each specific datasets included in the hybrid sample; for example, one or more online data sets and/or one or more offline data sets.
The hybrid sample in its entirety, including consideration of the online community, offline community, and overall hybrid community.

The method then statistically (or otherwise) compares this geodemographically profiled dataset (i.e. for the hybrid sample) to a geodemographically profiled target population to determine its representativeness and/or fitness for purpose.

It will be apparent, given the benefit of the teaching herein, that other options are available. For example, in an embodiment, the community is recruited and operated, and the input from an identified subset of the community—where the demographic profile for that subset is highly representative of the demographic profile of the target community—is more heavily weighted. The input from the community as a whole is in some embodiments still used—together with an indication of the representativeness—to assist in the understanding of the composition and views of the community. For this allows those who wish to contribute to do so, without skewing the results of the research. It has also been found that having willing participants in online discussions and blogs assist progress those discussions, and often allows more feedback to be obtained from the community as a whole, including from the selected subset.

In this description use is made of the term representativeness generally, although not entirely strictly, in a statistical sense. That is, the term is used to refer to the calculated correlation of the views expressed by a community or panel relative to a target population. A sample need not be exclusively statistically representative in all cases, provided that based on a subjective/objective assessment it is determined as fit for a specific purpose.

In some market research the target population is a subset of the customers that have been identified as being of interest, and the community is recruited and/or analyzed relative to that target population.

The embodiments making use of the recruiting or populating steps described above make use of a method of populating a community from an available population having a plurality of members, where the method includes the steps of:

a) defining a demographic profile for a target population;

b) obtaining a first dataset relating to the available population, where the first dataset collectively includes first demographic data for each member of the community; and

c) being responsive to the first dataset and a demographic profile for selecting members to populate the community.

Step (c) preferably includes: being responsive to the first dataset for generating a demographic profile for the community; and then being responsive to the demographic profile for community and the demographic profile for the target population for generating an indication of the representativeness of the community relative to the target population.

The method above is performed with a system of populating a community from an available population having a plurality of members, where the system includes:

a) memory for storing: data indicative of a demographic profile for a target population; and a first dataset relating to the available population, where the first dataset collectively includes first demographic data for each member of the community; and

b) a processor that is responsive to the first dataset and a demographic profile for selecting members to populate the community.

The use of tagging of individual members with geo-demographic data also provides a very robust set of variables to generate individual profiles and community profiles. Accordingly, the profile of the community is able to be iteratively refined member selection—that is, by including and removing different members—to arrive at a robustly generated community profile that has little skew from the target profile. In any event, the skew, or lack of representativeness, will still be assessable. This refinement of the community is able to be done without disturbing the normal actions and interactions of all the members in the online discussions and feedback sessions.

It will be appreciated that the disclosure above provides various significant systems and methods for undertaking market research of a target population.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, for example, from registers and/or memory to transform that electronic data into other electronic data that, for example, may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, for example, a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (for example, software) including a set of instructions to cause performing, when executed by one or more processors, one of more of the methods described herein. Note that when the method includes several elements, for example, several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, for example, networked to other another processor or other processors, in a networked deployment, the one or more processors may operate in the capacity of a server or a user machine in server-user network environment, or as a peer machine in a peer-to-peer or distributed network environment. The one or more processors may form a personal computer (PC), a cloud computer; a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagrams only show a single processor and a single memory that carries the computer-readable code, those in the art will understand that many of the components described above are included, but not explicitly shown or described in order not to obscure the inventive aspect. For example, while only a single machine is illustrated, the term “machine”, “processor” and “computer” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, for example, a computer program that is for execution on one or more processors, for example, one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, for example, a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (for example, a computer program product on a computer-readable storage medium) carrying computer-readable program code embodied in the medium.

The software may further be stored, transmitted or received over a network via a network interface device. While the carrier medium is shown in an exemplary embodiment to be a single medium, the term “carrier medium” should be taken to include a single medium or multiple media (for example, a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem.

It will be understood that the steps of methods discussed are performed in one embodiment by an appropriate processor (or processors) of a processing (that is, a computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer-implemented method for undertaking market research of a target population, the method including the steps of:
providing an online facility for cultivating an online community and obtaining market research response data from that online community, the community having a plurality of members, the community being a subset of the target population;
identifying data indicative of a first dataset relating to the community, wherein the first dataset collectively includes first demographic data for each member of the community;
using a microprocessor, comparing the first dataset with a demographic dataset, thereby to create a demographic profile for the community; and
using a microprocessor, comparing the demographic profile for the community with a demographic profile for the target population, thereby to generate data indicative of the representativeness of the community relative to the target population.

2. A method according to claim 1 wherein the demographic profile is based upon one or more segments, wherein each segment is defined by a selection of demographic criteria.

3. A method according to claim 2 wherein the data indicative of representativeness of the community relative to the target population includes data indicative of the relative proportion of the community satisfying the demographic criteria for a given segment contrasted with data indicative of the relative proportion of the target population satisfying the demographic criteria for that segment.

4. A method according to claim 1 including the step of obtaining a second dataset relating to the target population, where the second dataset collectively includes second demographic data for each member of the target population.

5. A method according to claim 4 wherein the demographic profile for the target population is derived from one or both of: the second dataset; and the demographic dataset.

6. A method according to claim 4 wherein the first demographic data and the second demographic data are for corresponding demographic characteristics of the respective populations.

7. A method according to claim 4 wherein the demographic profile is based upon one or more segments, wherein each segment is defined by a selection of demographic criteria.

8. A method according to claim 7 wherein the data indicative of representativeness of the community relative to the target population includes data indicative of the relative proportion of the community satisfying the demographic criteria for a given segment contrasted with data indicative of the relative proportion of the target population satisfying the demographic criteria for that segment.

9. A method according to claim 1 wherein the demographic dataset is derived from is census data for a population.

10. A method according to claim 1 including defining a demographic profile for the target population; and
using a microprocessor, comparing the a first dataset with the demographic profile, and based on that comparison selecting members of an available population to populate the community thereby to control the representativeness of the community relative to the target population.

11. A method according to claim 4 wherein the first demographic data and the second demographic data are for corresponding demographic characteristics of the respective populations.

12. A method according to claim 11 wherein the demographic characteristics include one or both of: age characteristics for each member of the relevant population; and location characteristics for each member of the population.

13. A method according to claim 11 wherein in the demographic characteristics include one or more of: age; socioeconomic status indicators such as at least one of income, education, and occupational status; household and family composition; cultural factors such as one or more of ethnicity, language spoken, country of birth, and religion; employment factors such as type of job, type of industry, and hours of work; and
household economic factors, like indebtedness, investments, and poverty.

14. A non-transitory computer-readable storage medium with an executable program stored thereon, wherein the program instructs a microprocessor to perform the method of claim 1.

15. A non-transitory computer-readable storage medium according to claim 14 wherein the demographic profile is based upon one or more segments, wherein each segment is defined by a selection of demographic criteria.

16. A non-transitory computer-readable storage medium according to claim 15 wherein the data indicative of representativeness of the community relative to the target population includes data indicative of the relative proportion of the community satisfying the demographic criteria for a given segment contrasted with data indicative of the relative proportion of the target population satisfying the demographic criteria for that segment.

17. A non-transitory computer-readable storage medium according to claim 14 wherein the method includes obtaining a second dataset relating to the target population, where the second dataset collectively includes second demographic data for each member of the target population.

18. A non-transitory computer-readable storage medium according to claim 17 wherein the demographic profile for the target population is derived from one or both of: the second dataset; and the demographic dataset.

19. A non-transitory computer-readable storage medium according to claim 18 wherein the first demographic data and the second demographic data are for corresponding demographic characteristics of the respective populations.

20. A machine for undertaking market research of a target population, the machine comprising:
a microprocessor coupled to a memory, wherein the microprocessor is programmed to:
provide an online facility for cultivating an online community and obtaining market research response data from that online community, the panel being a community having a plurality of members, the community being a subset of the target population;
access a first dataset relating to a community, wherein the first dataset collectively includes first demographic data for each member of the community;
compare the first dataset with a demographic dataset, thereby to create a demographic profile for the community; and
comparing the demographic profile for the community with a demographic profile for the target population, thereby to generate data indicative of the representativeness of the community relative to the target population.
